(19) United States
(12) Patent Application Publication
(10) Pub. No.: US 2020/0043398 A1
(43) Pub. Date: Feb. 6, 2020

(54) Photoexcited Quantum Dot Based Augmented Reality Displays

(71) Applicant: David Viveros Salazar, Redwood City, CA (US)

(72) Inventor: David Viveros Salazar, Redwood City, CA (US)

(21) Appl. No.: 16/529,634

(22) Filed: Aug. 1, 2019

Related U.S. Application Data
(60) Provisional application No. 62/712,995, filed on Aug. 1, 2018.

(51) Int. Cl. G09G 3/20; G09G 3/32; G02F 1/29; G02B 27/01

(52) U.S. Cl. CPC G09G 3/2003; G09G 3/32; G09G 2320/0666; G02B 27/0172; G02F 1/29

(57) ABSTRACT

A multi-layer display includes a substrate and an array of quantum dots arranged as pixels. Each pixel includes multiple subpixels. Each subpixel of a pixel is configured to emit a respective one of multiple colors when excited. A projector projects a monochromatic image at the multi-layer display to photoexcite selectable ones of the subpixels to cause the selectable subpixels to project a multi-color version of the image. The multi-layer display may be transparent, and the projector may direct the monochromatic image at a front surface of the multi-layer display, at an angle, to permit an observer to view the multi-color image superimposed over a real-world environment of the observer. In another embodiment, a rear surface of the multi-layer display includes a mirror-like coating, and the projector directs the monochromatic image at the rear surface to superimpose the multi-color image over a mirror image of the observer.

### CROSS REFERENCE TO RELATED APPLICATIONS

This application claims the benefit of U.S. Provisional Patent Application No. 62/712,995, filed Aug. 1, 2018, which is incorporated herein by reference in its entirety.

### BACKGROUND

Quantum dots (QDs) are tiny semiconductor particles a few nanometres in size. When quantum dots are excited or stimulated (e.g., illuminated by UV light), some of the electrons receive enough energy to break free from the atoms. When these electrons drop back into the outer orbit around the atom (the valence band), they emit light. The color of the light depends on the energy difference between the conductance band and the valence band. Larger QDs (e.g., 5-6 nm diameter) emit longer wavelengths (e.g., orange or red). Smaller QDs (e.g., 2-3 nm diameter) emit shorter wavelengths (e.g., blue and green). Actual colors and sizes vary based on composition of the quantum dots.

Quantum Dots may be employed as photo-emissive/photoluminescent devices (i.e., excited by light), or electro-emissive/electroluminescent devices (electrically excited).

Conventional photo-emissive quantum dot displays utilize backlighting, which precludes use of in transparent or see-through applications, such as augmented reality devices and heads-up displays.

### BRIEF DESCRIPTION OF THE DRAWINGS/FIGURES

FIG. 1 is a block diagram of a display device that includes a multi-layer display and a projector.

FIG. 2 is an illustration quantum dots arranged as an array of pixels.

FIG. 3 is a block diagram of a display device that includes a transparent multi-layer display and a projector.

FIG. 4 is a block diagram of a projector configured to project a monochromatic version of an image at a display to photoexcite selectable subpixels of quantum dots of the display.

FIG. 5 is diagram of the display device of FIG. 3, further including mounting hardware to maintain the transparent multi-layer display and the projector display in fixed positions relative to one another.

FIG. 6 is a block diagram of a display device that includes a multi-layer display and a projector configured to present a multi-color virtual object/image superimposed over a mirror reflection of an observer.

FIG. 7 is a diagram of a display device in combination with other technologies.

FIG. 8 is a flowchart of a method of photoexciting an array of quantum dots.

FIG. 9 is a block diagram of a computer system configured to control a projector to photoexcite an array of quantum dots.

In the drawings, the leftmost digit(s) of a reference number identifies the drawing in which the reference number first appears.

### DETAILED DESCRIPTION

Disclosed herein are methods and systems to fabricate/construct and utilize quantum dot displays.

In an embodiment, a transparent head-mounted display uses photoexcited quantum dots (QDs) to create a color image for an observer. A liquid crystal polarization array converts an ultraviolet (UV) light source into a 1-dimensional (1D) or 2-dimensional (2D) monochromatic image. The monochromatic image is then projected or propagated onto a transparent substrate of quantum dots. The transparent display absorbs the monochromatic image and emits a full color image. The full color image is then seen by an observer wearing a head-mounted display. Methods and systems disclosed herein are not, however, limited to head-mounted displays or transparent displays. Other examples provided herein include, without limitation, augmented reality mirror devices and simultaneous location and mapping (SLAM) devices.

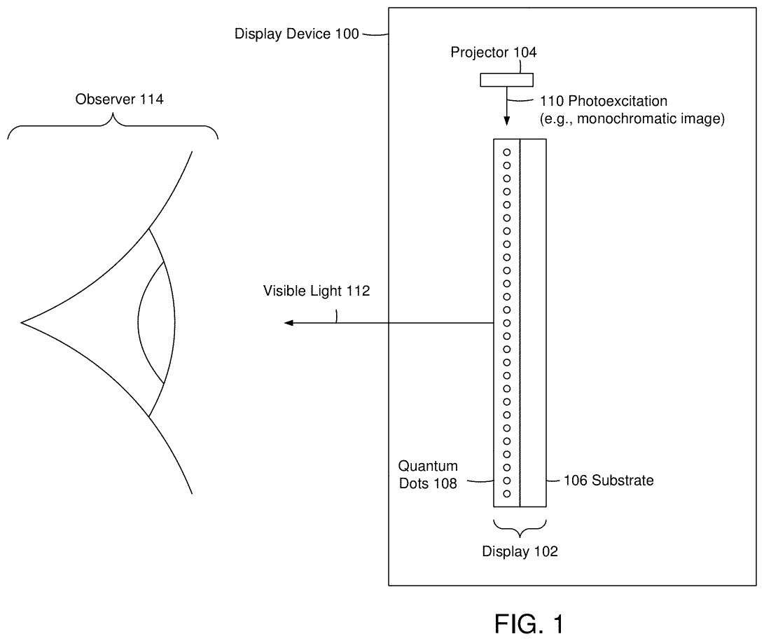

FIG. 1 is a block diagram of a display device 100 that includes a multi-layer display 102 and a projector 104.

Multi-layer display 102 includes a substrate 106 and quantum dots 108.

Projector 104 is configured photoexcite selectable ones of quantum dots 108 with photoexcitation 110 to cause quantum dots 108 to emit visible light 112, which may be viewed by an observer 114. Visible light 112 may include a 1-dimensional or 2-dimensional image, which may include text and/or a virtual image.

Quantum dots 108 may include multiple types of quantum dots, such as red, green, and blue light emitting quantum dots. Quantum dots 108 are not, however, limited to the foregoing example colors.

Quantum dots 108 may be arranged as an array of pixels, with each pixel including multiple subpixels, and with each subpixel including a corresponding one of the multiple types/colors of quantum dots. In this embodiment, projector 104 is configured to photoexcite selectable subpixels/colors of quantum dots 108 within selectable pixels to cause display 102 to emit visible light 112 as a 1-dimensional or 2-dimensional multi-color image.

Quantum dots 108 may be fabricated with one or more of a variety of techniques. In an embodiment, quantum dots 108 are deposited on a surface of substrate 106, such as with microcontact printing. The multiple types of quantum dots may be printed onto substrate 106 to provide red, green, and blue quantum dot printed areas approximately 10-100 microns in diameter. The quantum dot areas may be printed uniformly over substrate 106. Quantum dots 108 are not, however, limited to microcontact printing.

In an embodiment, projector 104 projects photoexcitation 110 in an ultra-violet (UV) range (e.g., ˜365 nm), which may be generated with light emitting diodes (LEDs). Photoexcitation 110 is not, however, limited to the UV region. If quantum dots 108 are designed to absorb in other regions (e.g., near-infrared region), projector 104 will include a corresponding light source.

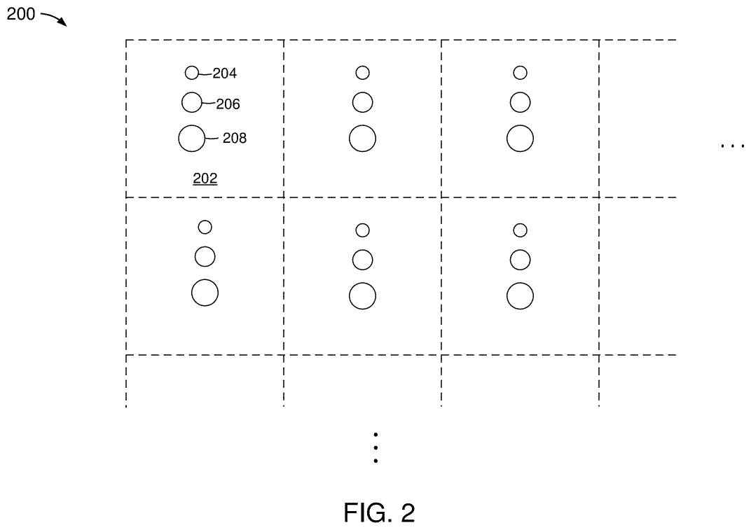

FIG. 2 is an illustration quantum dots 200 arranged as an array of pixels 202. In the example of FIG. 2, each pixel 202 includes subpixels 204, 206, and 208. Each of subpixels 204, 206, and 208 may be configured to emit respective colors of visible light (e.g., green, blue, and red, respectively). Each subpixel 204, 206, and 208 may include multiple quantum dots of the respective type/color. For example, subpixel 204 may include multiple quantum dots, each configured to emit green light when photoexcited. A projector may be configured to selectively photoexcite all quantum dots of a subpixel, or a subset of quantum dots within a subpixel. In an embodiment, subpixel areas for each pixel may be arranged in a Bayer color filter pattern. The area of each subpixel may range between 100-10,000×10⁻⁶ m².

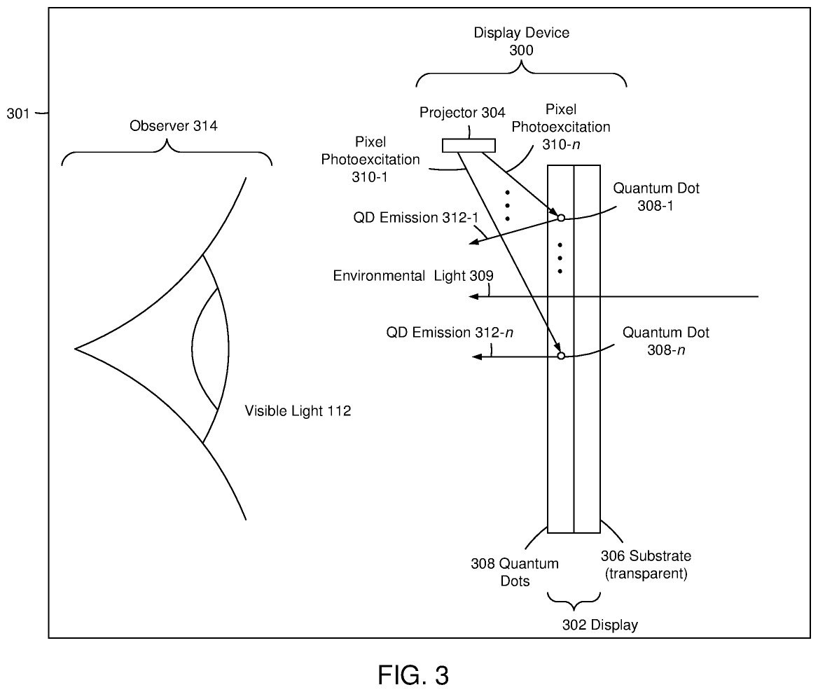

In FIG. 1, substrate 106 may be transparent to visible light, which falls in the range of the electromagnetic spectrum between infrared (IR) and ultraviolet (UV) (i.e., between approximately 740 nanometers (nm) and 380 nm). An example is provided below with reference to FIG. 3.

FIG. 3 is a block diagram of a display device 300 that includes a transparent multi-layer display (display) 302 and a projector 304. Display 302 includes quantum dots 308 and a substrate 306 that is transparent to visible light. Substrate 306 may be fabricated from one or more of a variety of transparent materials, such as fused silica, polycarbonate, or acrylic. Substrate 306 is not, however, limited to the foregoing examples.

Projector 304 is configured to excite quantum dots 308 with photoexcitation 310 (e.g., collimated light/UV monochromatic image), to cause quantum dots 308 to emit visible light/quantum dot (QD) emissions 312.

In the example of FIG. 3, projector 304 is positioned outside of a line-of-sight between observer 314 and display 302. The position of projector 304 and the transparency of substrate 306 permits an observer 314 to view QD emissions 312, while simultaneously viewing an environment of observer 314 (i.e., environmental light 309) through display 302.

Display device 300 may be configured as an augmented reality (AR) device, a heads-up display, and/or a window display.

Augmented reality (AR) is an interactive experience in which a natural or real-world environment is enhanced or augmented with computer-generated perceptual information, sometimes across multiple sensory modalities, including visual (e.g., virtual images), auditory, haptic, somatosensory and olfactory. Overlaid sensory information may be constructive (i.e., additive to the natural environment), or destructive (i.e., masking of the natural environment). An AR device, as disclosed herein, may include virtual objects with simultaneous location and mapping (SLAM) capabilities. In this example, an observer may interact with SLAM enabled objects. The virtual objects may, for example, take the form of objects occupying space in a room (e.g. a desk and chair) of the observer.

As a window display, device 300 may be useful to provide recipes in a kitchen or advertisements on a window of a building, or on a wall of a building. Display device 300 is not, however, limited to the foregoing examples.

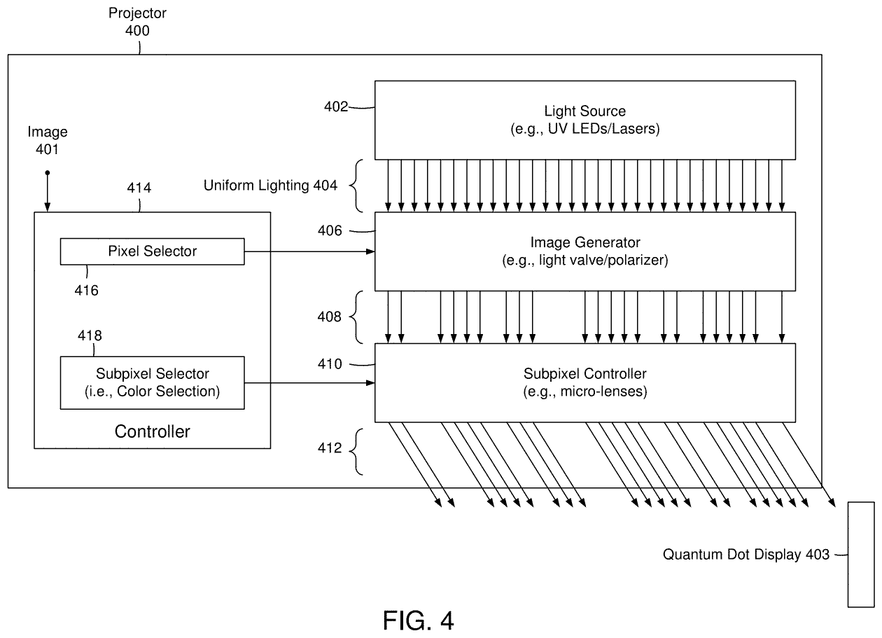

Projector 104 (FIG. 1) and/or projector 314 (FIG. 3) may be configured as described below with reference to FIG. 4.

FIG. 4 is a block diagram of a projector 400 configured to project a monochromatic version of an image 401 at a display 403 to photoexcite selectable subpixels of quantum dots of display 403.

Projector 400 includes a light source 402 to provide uniform lighting 404. Light source 402 may include, without limitation, lasers or an array of light emitting diodes and a diffuser.

A wavelength of light source 402 may be chosen based on a material of quantum dots of display 403. For example, ultra-violet light may be used for cadmium and/or indium-based quantum dots.

Projector 400 further includes an image generator 406 to convert uniform lighting 404 to a 1-dimensional or 2-dimensional monochromatic image 408. Image generator 406 may include light valves, a liquid crystal polarization array, and/or micro-lenses. Image 408 may include multiple collimated light beams, each corresponding to a respective pixel of image 401.

In an embodiment, light source 402 and image generator 406 are implemented as an array of micro light emitting diodes (microLEDs) to provide on chip collimation of the light. This may be useful to simplify system design.

Projector 400 further includes a subpixel controller 410 to aim or redirect collimated light beams of image 408 to selectable subpixels of display 403. The redirected collimated light beams of image 408 are illustrated here as an image 412. Subpixel controller 410 may include micro-lenses to aim or redirect collimated light beams of image 408 to selectable subpixels of display 403.

Subpixel controller 410 may include a telescoping lens to project monochromatic image 412 at display 403.

Subpixel controller 410 may include a corrective lens to apply horizontal and/or vertical keystone correction to image 412. This may be useful to correct for an angle of incidence of image 412 relative to a surface of display 403.

Projector 400 and/or display 403 may include one or more layers or coatings to facilitate transmittance, absorption, and/or reflectance of light along various points of the optical path. For example, display 403 may include an antireflective coating to prevent UV light of image 412 from reflecting toward an observer.

Projector 400 may include galvanometer mirrors to sweep a 1-dimensional image as a function of time to provide image 412 as a 2-dimensional image. This may be useful to provide a 2-dimensional image with reduced power consumption and a reduced number of optical components.

Projector 400 further includes a controller 414 to control image generator 406 and subpixel controller 410. Controller 414 may be configured to allocate computational resources associated with rendering of the monochromatic image, sensing of the environment via an on-board and/or off-board diagnostic suite, and uploading/downloading data to/from a network. Controller 414 may include a wireless communication device to communicate with local and/or extended communication networks.

In the example of FIG. 4, controller 414 includes a pixel selector 416 to control image generator 406 based on active pixels (e.g., non-black pixels) of image 401. Controller 414 further includes a subpixel selector 418 to control subpixel controller 410 based color information associated with respective pixels of image 401.

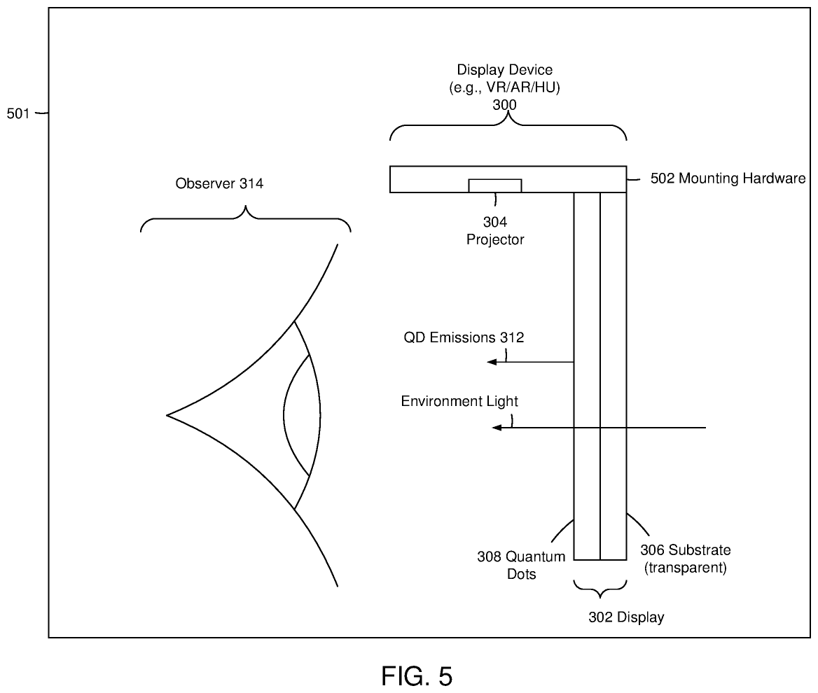

A display device as disclosed herein may include mounting hardware to maintain a display and a projector in fixed positions relative to one another, an example of which is provided below with reference to FIG. 5.

FIG. 5 is diagram of display device 300 (FIG. 3), further including mounting hardware 502 to maintain display 302 and projector 304 in fixed positions relative to one another. Mounting hardware 502 may be configured as a wearable device (e.g., head-mounted), or as wall-mountable device. Mounting hardware 502 is not, however, limited to the foregoing examples.

Mounting hardware 502 may resemble eyeglasses, and display device may further include a portable power supply (e.g., a lithium ion battery).

Where display device 300 is configured as a stationary device, display device may be powered by a stationary AC power source (e.g., a wall outlet).

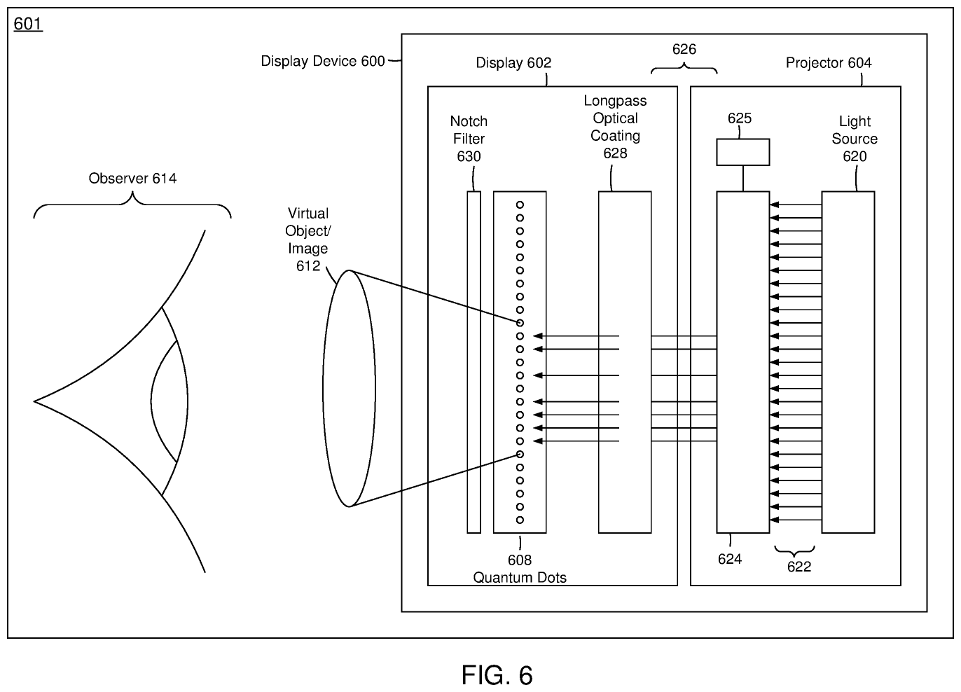

A display device, as disclosed herein, may be configured as an augmented reality mirror/display device. Examples are provided below with reference to FIG. 6.

FIG. 6 is a block diagram of a display device 600 that includes a display 602 and a projector 604 configured to present a multi-color virtual object/image 612, superimposed over a mirror reflection of an observer 614.

Projector 604 includes a light source 620 to provide uniform lighting 622, and a light valve layer 624 to convert uniform lighting 622 to a monochromatic image source 620. Projector 604 may further include a processor 625, such as described above with respect to processor 414 in FIG. 4.

Display 602 includes a quantum dots 608, which may be disposed over a transparent substrate.

Display 602 further includes a longpass optical layer or coating 628 to permit monochromatic image 626 to pass through to quantum dots 608, while providing a mirror-like appearance to an observer 614. Quantum dots 608 are configured to convert monochromatic image 626 to multi-color virtual object/image 612, such as described in one or more examples herein. In this way, observer 614 may view virtual object/image 612 superimposed over a mirror reflection of an observer 614.

Display 602 further includes a notch filter to prevent light (e.g., UV light) of monochromatic image 626 from harming observer 614.

Display device 600 may be useful to provide augmented mirror images for small mirror areas like cosmetics applications and/or to larger mirrors (e.g., full body-length mirrors). Virtual object/image 612 may include, for example, a wearable article (e.g., clothing or accessory), to permit observer 614 to visualize the wearable article superimposed over a mirror reflection of observer 614.

Display device 600 may be useful in an environment where display of information would allow a relatively challenging task to be performed hands free. Some examples include car mirrors to alert drivers of potential hazards, or mirrors in surgery rooms to assist surgeons with identification of objects.

A display device as disclosed herein may include one or more sensors, which may include environmental sensors. Relatively simple sensors may be used to present passive data, such as time of day or air temperature, to an observer (e.g. as image 412 in FIG. 4). More extensive sensing capabilities may be useful to provide mapping of an observer's environment (e.g., to account for occlusion of objects). Additionally, 3-dimensional sensing may be useful for simultaneous location and mapping (SLAM) capabilities, such as to provide virtual images on a display to augment an observable environment.

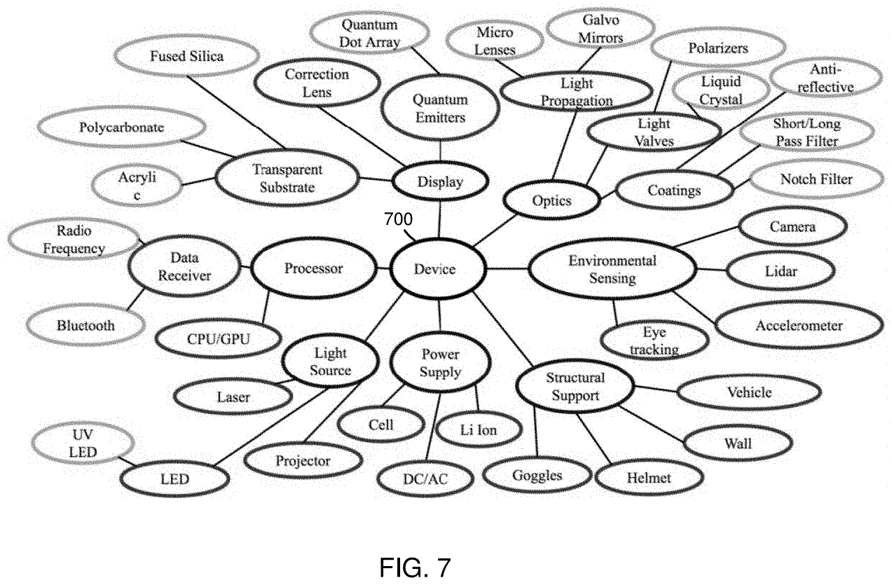

A display device as disclosed herein may be combined with one or more other technologies, examples of which are illustrated in FIG. 7.

FIG. 7 is a diagram of a display device 700 in combination with other technologies. A display device as disclosed herein is not, however, limited to the examples of FIG. 7.

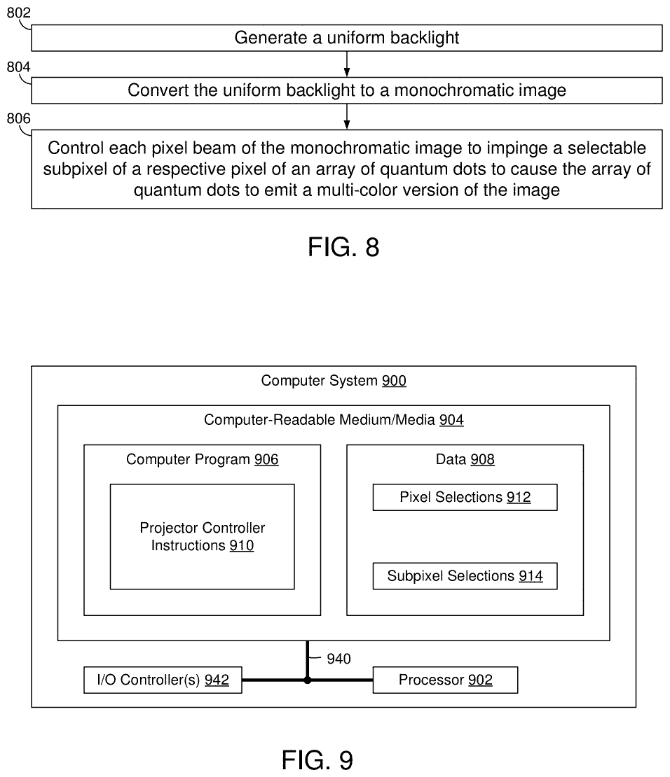

FIG. 8 is a flowchart of a method 800 of controlling a projector to photoexcite an array of quantum dots. More particularly, FIG. 8 is a flowchart of a method 800 of projecting a monochromatic image at a multi-layer display that includes a substrate and an array of quantum dots, wherein the quantum dots are arranged as pixels, wherein each pixel includes multiple subpixels, and wherein each subpixel of a pixel is configured to emit a respective one of multiple colors when excited.

At 802, a uniform backlight is generated, such as described in one or more examples herein.

At 804, the uniform backlight is converted to a monochromatic image, such as described in one or more examples herein.

At 806, each pixel beam of the monochromatic image is controlled to impinge a selectable subpixel of a respective pixel of the array of quantum dots to cause the multi-layer display to emit a multi-color version of the image, such as described in one or more examples herein.

The term “pixel beam” is used herein to refer to collimated light of an image, such as image 412 in FIG. 4.

One or more features disclosed herein may be implemented in, without limitation, circuitry, a machine, a computer system, a processor and memory, a computer program encoded within a computer-readable medium, and/or combinations thereof. Circuitry may include discrete and/or integrated circuitry, application specific integrated circuitry (ASIC), a system-on-a-chip (SOC), and combinations thereof.

FIG. 9 is a block diagram of a computer system 900 configured to control a projector to photoexcite an array of quantum dots. Computer system 900 may represent an example embodiment of controller 414 in FIG. 4.

Computer system 900 includes one or more instruction processors, illustrated here as a processor 902, to execute instructions of a computer program 906 encoded within a computer-readable medium 904. Computer-readable medium 904 further includes data 908, which may be used by processor 902 during execution of computer program 906, and/or generated by processor 902 during execution of computer program 906. Computer-readable medium 904 may include a transitory or non-transitory computer-readable medium

In the example of FIG. 9, computer program 906 includes projector controller instructions 910 to cause processor 902 to control a projector, such as described in one or more examples herein.

Computer system 900 further includes communications infrastructure 940 to communicate amongst devices and/or resources of computer system 900.

Computer system 900 further includes one or more input/output (I/O) devices and/or controllers 942 to interface with components of a projector, such as image generator 406 and/or subpixel controller 410 in FIG. 4.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

What is claimed is:

1. An apparatus, comprising:
a multi-layer display that includes a substrate and an array of quantum dots, wherein the quantum dots are arranged as pixels, wherein each pixel includes multiple subpixels, and wherein each subpixel of a pixel is configured to emit a respective one of multiple colors when excited; and
a projector configured to project a monochromatic image at the multi-layer display to photoexcite selectable ones of the subpixels to cause the multi-layer display to emit a multi-color version of the image.

2. The apparatus of claim 1, wherein:
the substrate is transparent to visible light;
the projector is further configured to project the monochromatic image at a first surface of the multi-layer display; and
the multi-layer display is configured to emit the multi-color version of the image from the first surface.

3. The apparatus of claim 2, further including:
mounting hardware to maintain the multi-layer display and the projector in fixed positions relative to one another, and to retain the projector outside of a line-of-sight between an observer and the first surface of the multi-layer display.

4. The apparatus of claim 2, wherein the first surface of the multi-layer display includes:
an anti-reflective coating to prevent the monochromatic image from reflecting toward an observer.

5. The apparatus of claim 2, wherein the projector further includes:
a corrective lens to apply keystone pre-correction to the monochromatic image based on an angle of incidence of monochromatic image relative to the first surface of the multi-layer display.

6. The apparatus of claim 2, further including:
a sensor to detect a physical feature an environment of an observer;
wherein the projector is configured to project the monochromatic image based on a location and a dimension of the physical feature of the environment.

7. The apparatus of claim 1, wherein:
the projector is configured to project the monochromatic image at a first surface of the multi-layer display;
the multi-layer display is configured to emit the multi-color version of the image from a second surface of the multi-layer display that is opposite the first surface;
the multi-layer display further includes an optical coating between the first surface and the array of quantum dots to reflect visible light that enters the multi-layer display through the second surface without obstructing the monochromatic image; and
the multi-layer device further includes a filter between the array of quantum dots and the second surface to prevent the monochromatic image from reaching the second surface.

8. The apparatus of claim 1, wherein the projector includes:
an electrically tunable array of micro-lenses configured to direct the monochromatic image at the selectable subpixels.

9. The apparatus of claim 1, wherein the projector includes:
a telescoping lens configured to magnify the monochromatic image.

10. The apparatus of claim 1, wherein the multi-layer display further includes:
an electrically tunable array of micro-lenses configured to set a focal distance of the emitted multi-color version of the image at a position between the multi-layer display and an observer.

11. A method, comprising:
projecting a monochromatic image at a multi-layer display that includes a substrate and an array of quantum dots, wherein the quantum dots are arranged as pixels, wherein each pixel includes multiple subpixels, and wherein each subpixel of a pixel is configured to emit a respective one of multiple colors when excited;
wherein the projecting includes,
generating a uniform backlight,
converting the uniform backlight to the monochromatic image, and
controlling each pixel beam of the monochromatic image to impinge a selectable subpixel of a respective pixel of the array of quantum dots to cause the multi-layer display to emit a multi-color version of the image.

12. The method of claim 11, wherein the substrate is transparent to visible light, and wherein the projecting further includes:
projecting the monochromatic image at a first surface of the multi-layer display to cause the multi-layer display to emit the multi-color version of the image from the first surface of the multi-layer display.

13. The method of claim 12, further including:
maintaining the multi-layer display and the projector in fixed positions relative to one another and retaining the projector outside of a line-of-sight between an observer and the first surface of the multi-layer display;
wherein the projecting further includes applying keystone pre-correction to the monochromatic image based on an angle of incidence of monochromatic image relative to the first surface of the multi-layer display.

14. The method of claim 11, further including:
detecting a physical feature an environment of an observer with a sensor;
wherein the projecting further includes projecting the monochromatic image based on a location and a dimension of the physical feature of the environment.

15. The method of claim 11, wherein:
the projecting further includes projecting the monochromatic image at first surface of the multi-layer display to cause the multi-layer display to emit the multi-color version of the image from a second surface of the multi-layer display that is opposite the first surface; and
the method further includes reflecting visible light that impinges the second surface of the multi-layer display and filtering a wavelength of the monochromatic image within the multi-layer display to prevent the wavelength of the monochromatic image from reaching an observer.

16. The method of claim 11, wherein the controlling includes:
controlling the pixel beams of the monochromatic image with an electrically controllable array of micro-lenses.

17. The method of claim 11, further including:
controlling an electrically tunable array of micro-lenses within the multi-layer display to set a focal distance of the multi-color version of the image at a position between the multi-layer display and an observer.

18. A non-transitory computer readable medium encoded with a computer program that includes instructions to cause a processor to:
control a projector to project a monochromatic image at a multi-layer display that includes a substrate and an array of quantum dots, wherein the quantum dots are arranged as pixels, wherein each pixel includes multiple subpixels, and wherein each subpixel of a pixel is configured to emit a respective one of multiple colors when excited, including to cause the projector to,
generate a uniform backlight,
convert the uniform backlight to the monochromatic image, and
control each pixel beam of the monochromatic image to impinge a selectable subpixel of a respective pixel of the array of quantum dots to cause the multi-layer display to emit a multi-color version of the image.

19. The non-transitory computer readable medium of claim 18, wherein the substrate of the multi-layer display is transparent to visible light, further including instructions to cause the processor to:
control the projector to project the monochromatic image at a first surface of the multi-layer display to cause the multi-layer display to emit the multi-color version of the image from the first surface of the multi-layer display.

20. The non-transitory computer readable medium of claim 18, wherein the multi-layer display includes an optical coating between a first surface of the multi-layer display and the array of quantum dots to reflect visible light that enters the multi-layer display through a second surface of the multi-layer display without obstructing the monochromatic image, further including instructions to cause the processor to:
control the projector to project the monochromatic image at the first surface of the multi-layer display to cause the multi-layer display to emit the multi-color version of the image from the second surface of the multi-layer display.
